(19) United States
(12) Patent Application Publication
(10) Pub. No.: US 2026/0311708 A1
(43) Pub. Date: Oct. 8, 2026

(54) AUDIO SIGNAL ENCODING METHOD, AND ELECTRONIC DEVICE AND STORAGE MEDIUM

(71) Applicant: BEIJING XIAOMI MOBILE SOFTWARE CO., LTD., Beijing (CN)

(72) Inventor: Shuo GAO, Beijing (CN)

(21) Appl. No.: 18/879,199

(22) PCT Filed: Jun. 30, 2022
(86) PCT No.: PCT/CN2022/103170

§ 371 Date: Dec. 26, 2024

(51) Int. Cl. G10L 19/008

(52) U.S. Cl. CPC G10L 19/008

(57) ABSTRACT

An audio signal encoding method includes: obtaining a scene-based audio signal; determining a number of audio channels of the audio signal and an encoding rate; and generating an encoded codestream by encoding the audio signal according to the number of audio channels and the encoding rate.

### CROSS-REFERENCE TO RELATED APPLICATION

The present application is a U.S. national phase of International Application No. PCT/CN2022/103170, filed on Jun. 30, 2022, the content of which is incorporated herein by reference in its entirety.

### TECHNICAL FIELD

The disclosure relates to a field of communication technologies, in particular to an audio signal encoding method, an audio signal encoding apparatus, an electronic device and a storage medium.

### BACKGROUND

In the related art, after acquiring an audio signal, the audio signal is subjected to a uniform encoding process. In the uniform encoding process, without considering the different encoding rates, a number of bits available for each audio channel is different, which causes the number of bits available for each audio channel to exceed or be less than a number of bits necessary for encoding. This results wasted of bits or the inability to provide an audio service that matches the encoding rate for remote users, which is an urgent problem to be solved.

### SUMMARY

According to a first aspect of embodiments of the disclosure, an audio signal encoding method is provided. The method includes: obtaining a scene-based audio signal; determining a number of audio channels of the audio signal and an encoding rate; and generating an encoded codestream by encoding the audio signal according to the number of audio channels and the encoding rate.

According to a second aspect of embodiments of the disclosure, an electronic device is provided. The electronic device includes at least one processor, and a memory communicatively connected to the at least one processor. The memory stores instructions executable by the at least one processor, and the at least one processor is configured to perform the method in the first aspect.

According to a third aspect of embodiments of the disclosure, a non-transitory computer-readable storage medium having computer instructions stored thereon is provided. When the computer instructions are executed by a processor, the processor is caused to perform the method in the first aspect.

### BRIEF DESCRIPTION OF THE DRAWINGS

In order to clearly illustrate technical solutions of embodiments of the disclosure or background technologies, a description of drawings used in the embodiments or the background technologies is given below.

FIG. 1 is a flowchart of an audio signal encoding method according to an embodiment of the disclosure.

FIG. 2 is a schematic diagram of a coordinate of an audio signal in a Firs-Order Ambisonics (FOA) format according to an embodiment of the disclosure.

FIG. 3 is a flowchart of another audio signal encoding method according to an embodiment of the disclosure.

FIG. 4 is a flowchart of an audio signal encoding method in the related art according to an embodiment of the disclosure.

FIG. 5 is a flowchart of yet another audio signal encoding method according to an embodiment of the disclosure.

FIG. 6 is a flowchart of substeps of step S30 in the audio signal encoding method according to an embodiment of the disclosure.

FIG. 7 is a flowchart of substeps of step S301 in the audio signal encoding method according to an embodiment of the disclosure.

FIG. 8 is a structural diagram of an audio signal encoding apparatus according to an embodiment of the disclosure.

FIG. 9 is a structural diagram of an encoding processing unit in an audio signal encoding apparatus according to an embodiment of the disclosure.

FIG. 10 is a structural diagram of a down-mixed processing module in an audio signal encoding apparatus according to an embodiment of the disclosure.

FIG. 11 is a structural diagram of another audio signal encoding apparatus according to an embodiment of the disclosure.

FIG. 12 is a structural diagram of an electronic device according to an embodiment of the disclosure.

### DETAILED DESCRIPTION

In order to make those skilled in the field better understand the technical solutions of this disclosure, the technical solutions in the embodiment of this disclosure will be described clearly and completely in combination with the attached drawings.

Unless the context indicates otherwise, throughout the specification and the claims, the term “comprise” is interpreted as open, inclusive, i.e., “includes, but is not limited to”. In the description of the specification, “some embodiments” is intended to indicate that certain features, structures, materials or characteristics related to the embodiments or examples are included in at least one embodiment or example of the disclosure. The schematic representation of the above term does not necessarily refer to the same embodiment or example. Furthermore, the features, structures, materials, or characteristics described above may be included in any one or more embodiments or examples in any suitable manner.

It should be noted that the terms “first” and “second” in the specification and the claims of this disclosure and the drawings are used to distinguish similar objects, and are not necessarily used to describe a specific order or sequence. The terms “first” and “second” are only used for descriptive purposes, and cannot be understood as indicating or implying relative importance or implicitly indicating the number of indicated technical features. Therefore, the features defined with the terms “first” and “second” may explicitly or implicitly include one or more of these features. It should be understood that data so used may be interchanged under appropriate circumstances, so that the embodiments of the disclosure described herein may be implemented in other orders than those illustrated or described herein. The implementations described in the following embodiments do not represent all implementations consistent with the disclosure. Rather, they are merely examples of devices and methods consistent with some aspects of the disclosure as detailed in the appended claims.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that may be understood by the communication device, and the values or representations of the parameters may be other values or representations that may be understood by the communication device. Each of the above tables may also be implemented with other data structures, such as, arrays, queues, containers, stacks, linear tables, pointers, chained lists, trees, graphs, structures, classes, heaps, and Hash tables.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

The first generation (1G) mobile communication technology is the first generation wireless cellular technology, which belongs to an analog mobile communication network. When 1G is upgraded to 2G, a mobile phone switches from an analog communication to a digital communication, and a global system for mobile communication (GSM) network standard is adopted. A voice encoder adopts an adaptive multi rate (AMR) narrow band speech codec, an enhanced full rate (EFR), a full rate (FR), and a half rate (HR), and a communication provides a single-channel narrowband voice service. A 3G mobile communication system was proposed by the International Telecommunication Union (ITU) for international mobile communications in 2000, which can adopt Time Division-Synchronous Code Division Multiple Access (TD-SCDMA), Code Division Multiple Access 2000 (CDMA2000), or Wideband Code Division Multiple Access (WCDMA), and the voice encoder of which adopts an adaptive multi-rate wideband (AMR-WB) to provide a single-channel broadband voice service. A 4G is improved base on the 3G technology. Both data and voice are transmitted in an all-IP manner, for providing a real-time high definition (HD)+Voice service of voice audio. An enhanced voice service (EVS) codec adopted by the 4G can balance a high-quality compression of voice and audio.

The voice and audio communication service provided above have expanded from a narrowband signal to an ultra-wideband service or even a full-band service, but they are all signal-audio channel services. With the increasing demand for high-quality audio, compared with the signal-audio channel audio, stereo audio has a sense of orientation and distribution for each sound source, and can improve a clarity.

With an increase of transmission bandwidth, an upgrade of a terminal device signal collection device, an improvement of performance of a signal processor, and an upgrade of a terminal playback device, three signal formats, namely audio channel-based multi-channel audio signals, object-based audio signals, and scene-based audio signals, can provide three-dimensional audio services. An immersive voice and audio service (IVAS) codec that is being standardized by the 3rd Generation Partnership Project (3GPP) SA4 can support encoding and decoding requirements of the above three signal formats. Terminal devices that can support 3D audio services include a mobile phone, a computer, a Pad, a conference system device, an augmented reality/virtual reality (AR/VR) device, a vehicle, etc.

A Firs-Order Ambisonics/High-Order Ambisonics (FOA/HOA) signal is a main scene-based audio signal. The FOA/HOA signal represents audio information collected at a certain position in an audio scene and is an immersive audio format whose audio quality gradually gets better with the increase of order. Different Ambisonics orders represent different numbers of audio signal components. That is, for an N-order Ambisonics signal, the number of Ambisonics coefficients is (N+1)*(N+1).

TABLE 1
the relationship between the Ambionics signal
order and the Ambionics coefficient

| | Ambisonics |
|---|---|
| | coefficient/number of audio |
| Ambisonics order | channels |
| 0 | 1 |
| 1 | 4 |
| 2 | 9 |
| 3 | 16 |
| 4 | 25 |
| 5 | 36 |
| 6 | 49 |

As shown in Table 1, the number of audio channels of Ambisonics increases rapidly with the increase of order. Correspondingly, an amount of encoded data also increases rapidly, as well as an encoding complexity. Meanwhile, due to the limitation of encoding rate, an encoding performance is greatly reduced. In order to reduce the encoding complexity, it is necessary to perform a down-mixed processing on an input initial audio channel. After the down-mixed process, the number of audio channels decreases, and the encoding complexity is reduced, so as to achieve a balance between the encoding complexity and the encoding performance.

In response to the problem of the waste of bits or the inability to provide the audio services that match the encoding rate for a remote user in the related art, the embodiment of the disclosure provides an audio signal encoding method and an audio signal encoding apparatus to solve the problems existing in the related art at least to some extent, so as to make full use of the available bits, provide the audio services that match the encoding rate for the remote user, and improve the user experience.

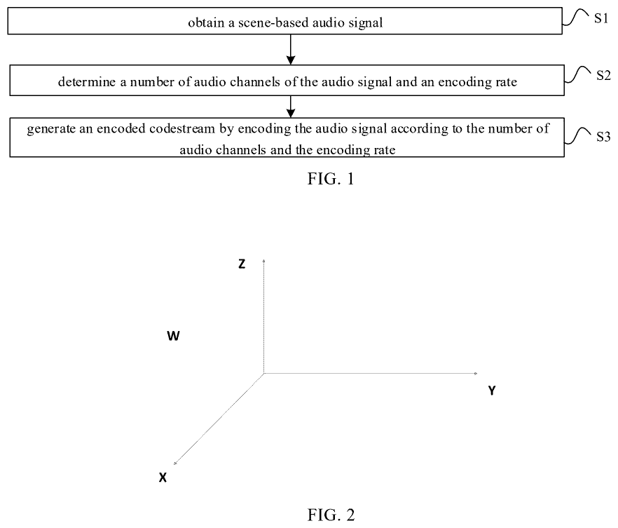

As illustrated in FIG. 1, FIG. 1 is a flowchart of an audio signal encoding method according to an embodiment of the disclosure.

As illustrated in FIG. 1, the method includes but is not limited to the following steps.

At step S1, a scene-based audio signal is obtained.

It is understood that when a local user establishes a voice communication with any remote user, the local user can establish a voice communication with a terminal device of the any remote user through a terminal device of the local user. The terminal device of the local user may obtain sound information of an environment where the local user is located in real time and obtain the scene-based audio signal.

The sound information of the environment where the local user is located includes sound information made by the local user and sound information of surrounding things. The sound information of surrounding things may be, for example, sound information of vehicle driving, sound information of birds, sound information of wind, and sound information of other users around the local user, and so on.

It should be noted that the terminal device is an entity on a user side for receiving or transmitting signals. For example, the terminal device may be a mobile phone, a computer, a Pad, a watch, an interphone, a conference system device, an augmented reality/virtual reality (AR/VR) device, a vehicle, etc. The terminal device may also be referred to as a user equipment (UE), a mobile station (MS), a mobile terminal (MT), and the like. The terminal device may be a vehicle with communication functions, a smart vehicle, a mobile phone, a wearable device, a Pad, a computer with wireless transceiver functions, a VR terminal device, an AR terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The specific technology and specific device form adopted by the terminal device are not limited in embodiments of the disclosure.

In the embodiment of the disclosure, when acquiring the scene-based audio signal, the terminal device of the local user can acquire the sound information of the environment where the local user is located via a recording apparatus, such as a microphone, arranged in the terminal device or cooperating with the terminal device, and then generate the scene-based audio signal to obtain the scene-based audio signal.

In the embodiment of the disclosure, the scene-based audio signal may be an audio signal in a FOA format or an audio signal in a HOA format.

At step S2, a number of audio channels of the audio signal and an encoding rate are determined.

In the embodiment of the disclosure, after obtaining the scene-based audio signal, the number of audio channels of the audio signal and the encoding rate are determined.

For example, as illustrated in FIG. 2, in a case where the scene-based audio signal is an audio signal in the FOA format, it is determined that the number of audio channels of the audio signal is 4, which may be represented by W, X, Y and Z, in which W represents a component containing all sounds in all directions in a sound field superimposed with the same gain and phase, X represents a component in a front-back direction in the sound field, Y represents a component in a left-right direction in the sound field, and Z represents a component in an up-down direction in the sound field. It is further determined that the selected encoding rate is 96 kbps.

At step S3, an encoded codestream is generated by encoding the audio signal according to the number of audio channels and the encoding rate.

In the embodiment of the disclosure, the scene-based audio signal is obtained, the number of audio channels of the audio signal and the encoding rate are determined, and the encoded codestream is generated by encoding the audio signal according to the number of audio channels and the encoding rate.

When encoding the audio signal according to the number of audio channels and the encoding rate, the encoding rate of each audio channel may be determined according to the number of audio channels and the encoding rate. For example, an average encoding rate of each audio channel, the maximum encoding rate of each audio channel, or the encoding rate of each audio channel may be determined. The average encoding rate of each audio channel may be determined by dividing the encoding rate by the number of audio channels, the maximum encoding rate of each audio channel is equal to the encoding rate, and the encoding rate of each audio channel is the encoding rate.

In a base of determining the encoding rate of each audio channel, the number of bits available for each audio channel may be considered at the different encoding rates according to the encoding rate of each audio channel, so that the bits available is able to be fully utilized during the encoding process, to avoid the waste of bits and provide the audio services matching the encoding rate for the remote user. The generated encoded codestream is able to provide clear, stable and understandable audio services when the encoding rate is low, and is able to provide high-definition, stable and immersive audio services when the encoding rate is high. In this way, it can provide the remote user with the audio services matching the encoding rate, thus improving the user experience.

In some embodiments, before encoding the audio signal, the method further includes: performing a pre-emphasis preprocessing and/or a high-pass filtering preprocessing on the audio signal.

In the embodiment of the disclosure, in a case where the scene-based audio signal is obtained and the number of audio channels of the audio signal and the encoding rate are determined, the pre-emphasis preprocessing may be performed on the audio signa, which may enhance a high-frequency portion of the audio information and increase a high-frequency resolution of the audio information.

In the embodiment of the disclosure, in a case where the scene-based audio signal is obtained and the number of audio channels of the audio signal and the encoding rate are determined, the high-pass filtering preprocessing may be performed on the audio signal, to filter signal components in the audio signal lower than a certain frequency threshold. A starting frequency in the high-pass filtering processing may be set as required, for example, the starting frequency may be set as 20 Hz.

After performing the high-pass filtering preprocessing on the audio signal, an audio signal component of the required encoding frequency band may be obtained. When the audio signal is encoded, an influence of an ultra-low frequency signal on encoding processing effects may be avoided.

By implementing the embodiments of the disclosure, the scene-based audio signal is obtained, the number of audio channels of the audio signal and the encoding rate are determined, and the encoded codestream is generated by encoding the audio signal according to the number of audio channels and the encoding rate. In this way, the audio signal is encoded according to the number of audio channels and the encoding rate, and the bits available are able to be fully utilized during the encoding process, so that the waste of bits may be avoided, and the audio services that match the encoding rate may be provided for the remote user.

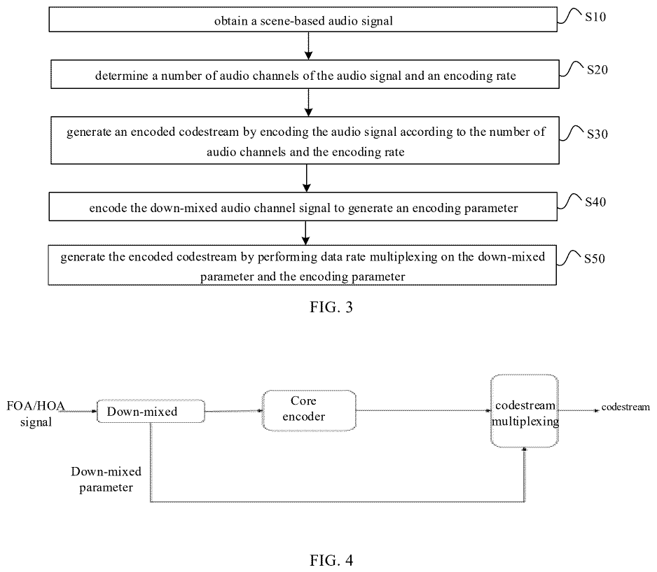

FIG. 3 is a flowchart of an audio signal encoding method according to an embodiment of the disclosure.

As illustrated in FIG. 3, the method includes but is not limited to the following steps.

At step S10, a scene-based audio signal is obtained.

At step S20, a number of audio channels of the audio signal and an encoding rate are determined.

In the embodiment of the disclosure, the related descriptions of steps S10 and S20 can be referred to the related descriptions in the above embodiments, and the same contents will not be repeated here.

At step S30, a down-mixed processing is performed on the audio signal according to the number of audio channels and the encoding rate, to generate a down-mixed parameter and a down-mixed audio channel signal.

At step S40, the down-mixed audio channel signal is encoded to generate an encoding parameter.

At step S50, the encoded codestream is generated by performing codestream multiplexing on the down-mixed parameter and the encoding parameter.

In the embodiment of the disclosure, the scene-based audio signal is obtained, the number of audio channels of the audio signal and the encoding rate are determined, and the encoded codestream is generated by encoding the audio signal according to the number of audio channels and the encoding rate. Encoding the audio signal according to the number of audio channels and the encoding rate may include performing the down-mixed processing on the audio signal according to the number of audio channels and the encoding rate to generate the down-mixed parameter and the down-mixed audio channel signal. The down-mixed audio channel signal is then encoded to generate the encoding parameter. The encoded codestream is generated by codestream multiplexing according to the down-mixed parameter and the encoding parameter.

As illustrated in FIG. 4, in the related art, after acquiring an audio signal (an audio signal in the FOA format or an audio signal in the HOA format), the audio signal is subjected to a uniform down-mixed process, and the number of audio channels after down-mixed is less than the initial number of audio channels. All the remaining channels are encoded by a core encoder, and down-mixed parameters generated by the down-mixed processing and output parameters of the core encoder are performed by codestream multiplexing to output the encoded codestream.

The uniform down-mixed processing of the audio signal does not consider that the number of bits available for each audio channel is different under different encoding rates, resulting in the number of audio channels after the down-mixed processing does not match the number of audio channels that the core encoder is able to encode. Therefore, when the number of audio channels after the down-mixed processing is much less than the number of input audio channels, better audio services cannot be provided to remote users at a high encoding rate (because the number of bits available for each audio channel exceeds the number of bits necessary for encoding, which may lead to the waste of bits). When the number of audio channels after the down-mixed processing is slightly different from the number of input audio channels, the remote users cannot be provided with audio services that match the encoding rate at a low encoding rate (because the number of bits available for each audio channel is much less than the number of bits necessary for encoding, which may lead to a poor encoding quality of each audio channel).

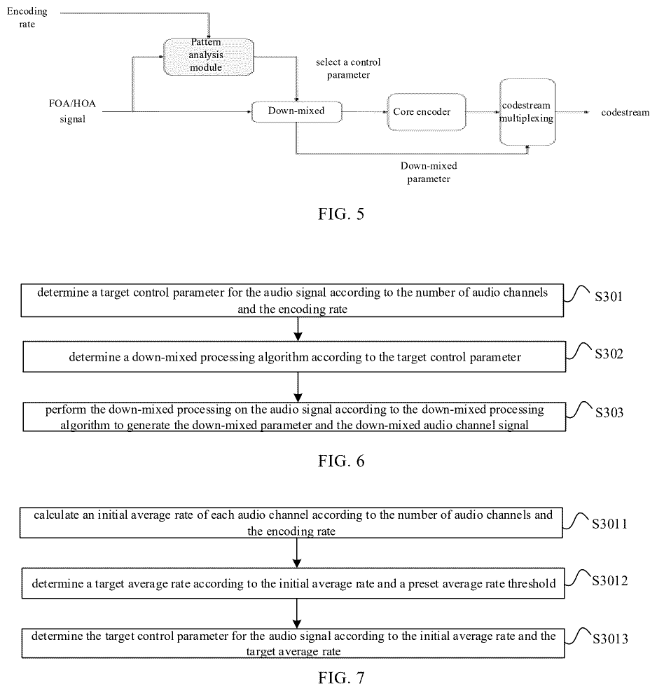

However, as illustrated in FIG. 5, in the embodiment of the disclosure, a scene-based audio signal (an audio signal in the FOA format or an audio signal in the HOA format) is input to an encoder end, the encoder end may determine the number of audio channels of the audio signal and the encoding rate and input the encoding rate, the number of audio channels and the audio signal to a pattern analysis module, or the encoder end may perform a high-pass filtering preprocessing on the audio signal and then input the preprocessed audio signal into the pattern analysis module.

The pattern analysis module may output a control parameter according to the selected encoding rate and the number of audio channels, and use the control parameter to guide a down-mixed processing module to select a corresponding down-mixed processing algorithm. The down-mixed processing module outputs a down-mixed parameter and a down-mixed audio channel signal after processing the audio signal. An encoding parameter is output after encoding the down-mixed audio channel signal by the core encoder. The encoding parameter and the down-mixed parameter are input to a codestream multiplexer to output an encoded codestream.

In the embodiment of the disclosure, when the input scene-based audio signal is the audio signal in the FOA format/the audio signal in the HOA format, a matching down-mixed processing algorithm is adaptively selected according to the number of audio channels of the input audio signal and the number of bits available, so that the number of audio channels after the down-mixed processing matches the number of audio channels that may be encoded by the core encoder at this encoding rate, and a full (optimal) utilization of bits available may be achieved. That is, at a low rate, it may ensure the provision of clear, stable and understandable audio services, and at a high rate, it may ensure the provision of high-definition, stable immersive audio services, which may improve the user experience.

In the embodiment of the disclosure, after the encoder outputs the encoded codestream, the encoded codestream may be sent to a decoder end for decoding, so that the remote terminals may obtain sound information transmitted by the local terminal.

As illustrated in FIG. 6, in some embodiments, step S30 of performing the down-mixed processing on the audio signal according to the number of audio channels and the encoding rate to generate the down-mixed parameter and the down-mixed audio channel signal, includes the following steps.

At step S301, a target control parameter for the audio signal is determined according to the number of audio channels and the encoding rate.

In the embodiment of the disclosure, when performing the down-mixed processing on the audio signal according to the number of audio channels and the encoding rate, the target control parameter for the audio signal may be determined according to the number of audio channels and the encoding rate.

When determining the target control parameter for the audio signal according to the number of audio channels and the encoding rate, the encoding rate of each audio channel may be determined according to the number of audio channels and the encoding rate. For example, an average encoding rate of each audio channel, the maximum encoding rate of each audio channel, or the encoding rate of each audio channel may be determined. The average encoding rate of each audio channel is determined by dividing the encoding rate by the number of audio channels, the maximum encoding rate of each audio channel is equal to the encoding rate, and the encoding rate of each channel is the encoding rate.

In the embodiment of the disclosure, on the basis of determining the encoding rate of each audio channel according to the number of audio channels and the encoding rate, the target control parameter for the audio signal is determined according to the encoding rate of each audio channel.

Certainly, when determining the target control parameter for the audio signal according to the number of audio channels and the encoding rate, by pre-setting corresponding relationships between the number of audio channels and the encoding rate and the control parameter, in a case of determining the number of audio channels of the audio signal and the encoding rate, the target control parameter for the audio signal may be determined.

Alternatively, a target number of audio channels may be determined according to the number of audio channels and the encoding rate, and then the target control parameter for the audio signal may be determined according to the target number of audio channels.

The target number of audio channels is determined according to the number of audio channels and the encoding rate. For example, N thresholds of the average encoding rate are preset, where N is a positive integer, and N+1 threshold ranges are determined by the N thresholds. Different threshold ranges are set to correspond to different numbers of audio channels after the down-mixed process. On the basis, an initial average encoding rate is calculated according to the number of audio channels and the encoding rate, and the target number of audio channels may be determined according to the threshold range to which the initial average rate belongs, and then the target control parameter for the audio signal is determined according to the target number of audio channels.

It is understood that in a case where the encoding rate and the number of audio channels after the down-mixed processing are known, an average rate that is able to be allocated to each audio channel after the down-mixed processing may be obtained, and the target control parameter for the audio signal may be determined according to the target number of audio channels and/or the average rate that is able to be allocated to each audio channel after the down-mixed processing.

When determining the target control parameter of the audio signal according to the target number of audio channels and/or the average rate that is able to be allocated to each audio channel after the down-mixed processing, corresponding relationships between the target number of audio channels and/or the average rate that is able to be allocated to each audio channel after the down-mixed processing and the control parameter may be preset, and the target control parameter for the audio signal may be determined according to the target number of audio channels and/or the average rate that is able to be allocated to each audio channel after the down-mixed processing.

At step S302, a down-mixed processing algorithm is determined according to the target control parameter.

In the embodiment of the disclosure, in a case where the target control parameter for the audio signal is determined according to the number of audio channels and the encoding rate, the down-mixed processing algorithm may be determined according to the target control parameter. Determining the down-mixed processing algorithm may be determining the down-mixed processing algorithm corresponding to each audio channel, and the determined down-mixed processing algorithms for different channels may be the same or different.

At step S303, the down-mixed processing is performed on the audio signal according to the down-mixed processing algorithm, to generate the down-mixed parameter and the down-mixed audio channel signal.

In the embodiment of the disclosure, in a case where the down-mixed processing algorithm corresponding to each audio channel is determined, the audio signal may be performed by the down-mixed processing according to the down-mixed processing algorithm to generate the down-mixed parameter and the down-mixed audio channel signal.

As illustrated in FIG. 7, in some embodiments, step S301 of determining the target control parameter for the audio signal according to the number of audio channels and the encoding rate, includes the following steps.

At step S3011, an initial average rate of each audio channel is calculated according to the number of audio channels and the encoding rate.

At step S3012, a target average rate is determined according to the initial average rate and a preset average rate threshold.

At step S3013, the target control parameter for the audio signal is determined according to the initial average rate and the target average rate.

According to the number of audio channels and the encoding rate, the initial average rate of each audio channel may be calculated by dividing the encoding rate by the number of audio channels. For example, when the number of audio channels is 4 and the encoding rate is 96 kbps, the initial average rate of each audio channel is calculated to be 24 kbps according to the number of audio channels and the encoding rate.

In the embodiment of the disclosure, in a case where the initial average rate of each audio channel is calculated, the target average rate may be determined according to the initial average rate and the preset average rate threshold.

The preset average rate threshold may be set according to the scene-based audio signal. For example, a first average rate threshold Thres1 is set to 13.2 kbps, and a second average rate threshold Thres2 is set to 32 kbps. According to the above two average rate thresholds, ranges corresponding to the average rate is divided into three average rate ranges, as follows,
an average rate range 1: less than or equal to 13.2 kbps;
an average rate range 2: greater than 13.2 kbps and less than 32 kbps; and
an average rate range 3: greater than or equal to 32 kbps.

In the embodiment of the disclosure, the target average rate is determined according to the initial average rate and the preset average rate threshold. When the average rate threshold range is determined according to the average rate threshold, the corresponding number of output audio channels is set for each average rate threshold range, so that the corresponding target number of output audio channels may be determined according to the average rate threshold range to which the initial average rate belongs.

On the basis, in a case where the target number of output audio channels is determined, the target average rate may be calculated according to the target number of output audio channels and the encoding rate.

For example, the number of output audio channels corresponding to the average rate range 1 is 2, the number of output audio channels corresponding to the average rate range 2 is 3, and the number of output audio channels corresponding to the average rate range 3 is 4. When the initial average rate is 24 kbps and belongs to the average rate range 2, it is determined that the target number of output audio channels is 3, and the target average rate may be calculated to be 96 kbps/3=32 kbps. It may be seen that the target average rate in the average rate range 2 is increasing compared to the initial average rate, so that the appropriate target control parameter may be determined when determining the target control parameter for the audio signal in subsequent processes, and the down-mixed processing algorithm may be determined according to the target control parameter. Therefore, the number of output audio channels after the down-mixed processing matches the number of audio channels that may be encoded by the core encoder at this encoding rate, and the optimal use of available bits may be achieved. That is, at a low rate, it may ensure the provision of clear, stable and understandable audio services, and at a high rate, it may ensure the provision of high-definition, stable immersive audio services, which may improve the user experience.

In the embodiment of the disclosure, for three average rate ranges, three different types of down-mixed processing algorithms may be selected for scene-based audio signals. After the selected down-mixed processing, an average rate available for each audio channel in the average rate range 1 and the average rate range 2 are increasing after the down-mixed processing. The average rate range 3 chooses not to perform the down-mixed processing because the encoding rate is rich enough, that is, an input signal is directly used as an output signal of the down-mixed processing, which means that the average rate available for each audio channel after the down-mixed processing remains unchanged.

For example, Table 2 shows some kinds of scene-based audio signals, initial average rates (average rates that may be allocated to each audio channel initially), preset average rate thresholds, as well as corresponding numbers of output audio channels (numbers of audio channels after the down-mixed processing) and determined target average rates (average rates that may be allocated to each audio channel after the down-mixed processing).

As can be seen from Table 2 below, the average rate that may be allocated to each audio channel after the down-mixed processing is greater than or equal to an average number of bits available for each audio channel, which may make full use of the available bits, avoid the waste of bits, and provide audio services that match the encoding rate for the remote users.

TABLE 2

| | | | Initial | | |
|---|---|---|---|---|---|
| | | | average | | |
| | | | rate | | Average rate |
| | | | (kbps) | Number | (kbps) that |
| | | | that | of audio | may be |
| | | | may be | channels | allocated to |
| Scene- | | | allocated | after the | each audio |
| based | Number | Coding | to each | down- | channel after |
| audio | of audio | rate | audio | mixed | down-mixed |
| signal | channels | (kbps) | channel | processing | processing |
| FOA | 4 | less | less | 2 | less than or |
| | | than or | than or | | equal to 26.4 |
| | | equal to | equal to | | |
| | | 52.8 | 13.2 | | |
| | | greater | greater | 3 | greater than |
| | | than 52.8 | than 13.2 | | 52.8/3 and |
| | | and less | and less | | less than 128/3 |
| | | than 128 | than 32 | | |
| | | greater | greater | 4 | greater than or |
| | | than or | than or | | equal to 32 |
| | | equal to | equal to | | |
| | | 128 | 32 | | |
| HOA2 | 9 | less | less | 5 | less than or |
| | | than or | than or | | equal to |
| | | equal to | equal to | | 118.8/5 |
| | | 118.8 | 13.2 | | |
| | | greater | greater | 7 | greater than |
| | | than 118.8 | than 13.2 | | 118.8/7 and |
| | | and less | and less | | less than 288/7 |
| | | than 288 | than 32 | | |
| | | greater | greater | 9 | greater than or |
| | | than or | than or | | equal to 32 |
| | | equal to | equal to | | |
| | | 288 | 32 | | |
| HOA3 | 16 | less | less | 8 | less than or |
| | | than or | than or | | equal to 26.4 |
| | | equal to | equal to | | |
| | | 211.2 | 13.2 | | |
| | | greater | greater | 12 | greater than |
| | | than 211.2 | than 13.2 | | 211.2/12 and |
| | | and less | and less | | less than |
| | | than 512 | than 32 | | 512/12 |
| | | greater | greater | 16 | greater than or |
| | | than or | than or | | equal to 32 |
| | | equal to | equal to | | |
| | | 512 | 32 | | |
| HOA4 | 25 | less | less | 14 | less than or |
| | | than or | than or | | equal to 330/14 |
| | | equal to | equal to | | |
| | | 330 | 13.2 | | |
| | | greater | greater | 20 | greater than |
| | | than 330 | than 13.2 | | 330/16 and |
| | | and less | and less | | less than |
| | | than 800 | than 32 | | 800/20 |
| | | greater | greater | 25 | greater than or |
| | | than or | than or | | equal to 32 |
| | | equal to | equal to | | |
| | | 800 | 32 | | |

It is understood that each element in Table 2 exists independently, and these elements are listed in the same table by way of example, but it does not mean that all the elements in the table must exist simultaneously as shown in the table. The value of each element is independent of any other element value in Table 2. Therefore, it is understood by those skilled in the art that the value of each element in Table 2 is an independent embodiment.

In the embodiment of the disclosure, a target average rate is determined according to an initial average rate and a preset average rate threshold. In addition to the above-mentioned example method, an average rate threshold closest to the initial average rate may be determined as the target average rate, or the initial average rate may be directly determined as the target average rate, or an average rate threshold, among average rate thresholds greater than the initial average rate, closest to the initial average rate may be determined as the target average rate, which is not specifically limited in the embodiment of the disclosure.

In the embodiment of the disclosure, after the target average rate is determined, when determining a target control parameter for an audio signal according to the initial average rate and the target average rate, corresponding relationships between the initial average rate and the target average rate and the control parameter may be preset. For example, corresponding relationships between the initial average rate and the target average rate and the control parameter are set, or corresponding relationships between the control parameter and a difference between the initial average rate and the target average rate are set, or corresponding relationships between the control parameter and an absolute value of a difference between the initial average rate and the target average rate are set, or corresponding relationships between the control parameter and a sum of the initial average rate and the target average rate, etc., which is not specifically limited in the embodiment of the disclosure.

A down-mixed processing algorithm is to design a down-mixed conversion matrix according to a target number of output audio channels and a number of audio channels for acquiring scene-based audio signals. For example, when the number of audio channels is N and the target number of output audio channels is M, the conversion matrix is M*N, and both N and M are positive integers, and M is less than or equal to N.

The conversion matrix M*N satisfies the following equation:

[M*1]=[M*N]*[N*1]
where [M*1] represents a matrix of M times 1, [M*N] represents a matrix of M times N, and [N*1] represents a matrix of N times 1.

For convenience of understanding, the embodiment of the disclosure provides an example.

In an embodiment, the scene-based audio signal obtained is an audio signal in a FOA format, the number of audio channels is 4, namely, W, X, Y, Z, and the selected encoding rate is 96 kbps. After the down-mixed processing, the target number of output audio channels is 3, where W represents a component containing all sounds in all directions in a sound field superimposed with the same gain and phase, X represents a component in a front-back direction in the sound field, Y represents a component in a left-right direction in the sound field, and Z represents a component in an up-down direction in the sound field. The schematic diagram of the coordinate is shown in FIG. 2.

When the target number of audio channels is 3 after the down-mixed processing, the component Z in the up-down direction is omitted, and only three channel components, W, X and Y are reserved. This strategy is made in consideration of two aspects. Firstly, when reconstructing the sound field, the listener at a playback end is sensitive to the component in the front-back direction and the component in the left-right direction, but less sensitive to the component in the up-down direction. Secondly, there are fewer sound sources for the component in the up-down direction in the sound field of a general audio scene. After the down-mixed processing, the number of audio channels is 3, and the average encoding rate that may be allocated to each audio channel is 96 kbps/3=32 kbps. An encoding core may encode and reconstruct high-quality audio signals at this average encoding rate, and provides high-definition, stable and immersive audio services to remote users.

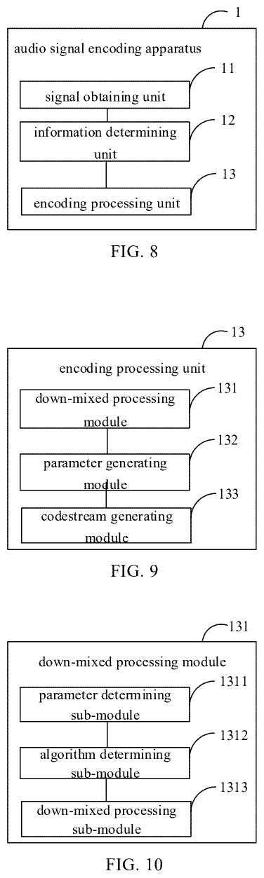

FIG. 8 is a structural diagram of an audio signal encoding apparatus provided by an embodiment of the disclosure.

As illustrated in FIG. 8, the audio signal encoding apparatus 1 includes: a signal obtaining unit 11, an information determining unit 12, and an encoding processing unit 13.

The signal obtaining unit 11 is configured to obtain a scene-based audio signal.

The information determining unit 12 is configured to determine a number of audio channels of the audio signal and an encoding rate.

The encoding processing unit 13 is configured to generate an encoded codestream by encoding the audio signal according to the number of audio channels and the encoding rate.

By implementing the embodiment of the disclosure, the signal obtaining unit 11 obtains a scene-based audio signal, the information determining unit 12 determines a number of audio channels of the audio signal and an encoding rate, and the encoding processing unit 13 generates a coded codestream by encoding the audio signal according to the number of audio channels and the encoding rate. In this way, the audio signal is encoded according to the number of audio channels and the encoding rate, and the bits available may be fully utilized during the encoding process, so that the waste of bits may be avoided, and audio services that match the encoding rate may be provided for remote users.

As illustrated in FIG. 9, in some embodiments, the encoding processing unit 13 includes: a down-mixed processing module 131, a parameter generating module 132, and a codestream generating module 133. One or more of the down-mixed processing module 131, the parameter generating module 132, and the codestream generating module 133 might be a circuitry (e.g., an ASIC or FPGA) and/or machine-readable instructions stored as software in a memory.

The down-mixed processing module 131 is configured to perform a down-mixed processing on the audio signal according to the number of audio channels and the encoding rate to generate a down-mixed parameter and a down-mixed audio channel signal.

The parameter generating module 132 is configured to encode the down-mixed audio channel signal to generate an encoding parameter.

The codestream generating module 133 is configured to generate the encoded codestream by performing codestream multiplexing on the down-mixed parameter and the encoding parameter.

As illustrated in FIG. 10, in some embodiments, the down-mixed processing module 131 includes: a parameter determining sub-module 1311, an algorithm determining sub-module 1312, and a down-mixed processing sub-module 1313.

The parameter determining sub-module 1311 is configured to determine a target control parameter for the audio signal according to the number of audio channels and the encoding rate.

The algorithm determining sub-module 1312 is configured to determine a down-mixed processing algorithm according to the target control parameter.

The down-mixed processing sub-module 1313 is configured to perform the down-mixed processing on the audio signal according to the down-mixed processing algorithm to generate the down-mixed parameter and the down-mixed audio channel signal.

In some embodiments, the parameter determining sub-module 1311 is further configured to:
calculate an initial average rate of each channel according to the number of audio channels and the encoding rate;
determine a target average rate according to the initial average rate and a preset average rate threshold; and
determine the target control parameter for the audio signal according to the initial average rate and the target average rate.

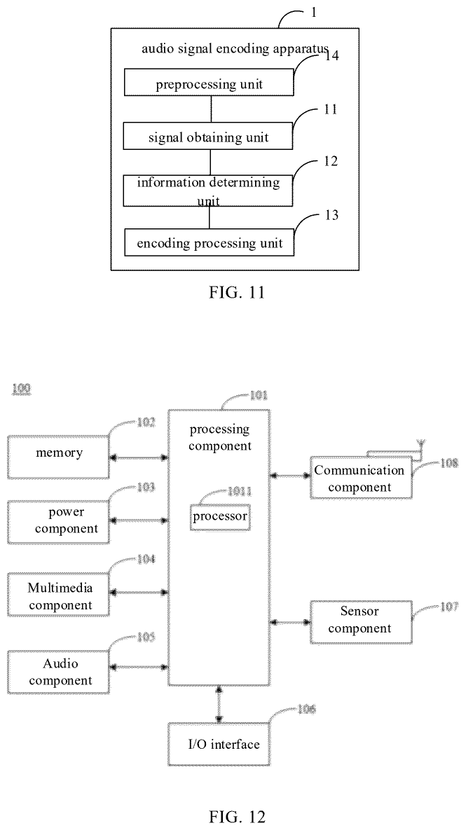

As illustrated in FIG. 11, in some embodiments, the audio signal encoding apparatus 1 further includes: a preprocessing unit 14.

The preprocessing unit 14 is configured to perform a pre-emphasis preprocessing and/or a high-pass filtering preprocessing on the audio signal.

With regard to the apparatus in the above embodiments, the specific way in which each module performs operations has been described in detail in the embodiments of the method, and will not be described in detail here.

The audio signal encoding apparatus according to the embodiment of the disclosure may execute the audio signal encoding methods as described in some of the above embodiments, and its beneficial effects are the same as those of the above audio signal encoding methods, which are not repeated here.

FIG. 12 is a structural diagram of an electronic device 100 for performing an audio signal encoding method illustrated by an embodiment.

For example, the electronic device 100 may be a mobile phone, a computer, a digital broadcasting terminal, a message transceiver device, a game console, a tablet device, a medical device, a fitness device or a personal digital assistant.

As illustrated in FIG. 12, the electronic device 100 may include one or more of the following components: a processing component 101, a memory 102, a power component 103, a multimedia component 104, an audio component 105, an input/output (I/O) interface 106, a sensor component 107, and a communication component 108.

The processing component 101 typically controls overall operations of the electronic device 100, such as the operations associated with display, telephone calls, data communications, camera operations, and recording operations. The processing component 101 may include one or more processors 1011 to perform all or part of the steps in the above described methods. Moreover, the processing component 101 may include one or more modules which facilitate the interaction between the processing component 101 and other components. For example, the processing component 101 may include a multimedia module to facilitate the interaction between the multimedia component 104 and the processing component 101.

The memory 102 is configured to store various types of data to support the operation of the electronic device 100. Examples of such data include instructions for any applications or methods operated on the electronic device 100, contact data, phonebook data, messages, pictures, video, etc. The memory 102 may be implemented using any type of volatile or non-volatile memory devices, or a combination thereof, such as a Static Random-Access Memory (SRAM), an Electrically-Erasable Programmable Read Only Memory (EEPROM), an Erasable Programmable Read Only Memory (EPROM), a Programmable Read Only Memory (PROM), a Read Only Memory (ROM), a magnetic memory, a flash memory, a magnetic or optical disk.

The power component 103 provides power to various components of the electronic device 100. The power component 103 may include a power management system, one or more power sources, and any other components associated with the generation, management, and distribution of power in the electronic device 100.

The multimedia component 104 includes a touch screen providing an output interface between the electronic device 100 and the user. In some embodiments, the screen may include a Liquid Crystal Display (LCD) and a Touch Panel (TP). The touch panel includes one or more touch sensors to sense touches, swipes, and gestures on the touch panel. The touch sensor may not only sense a boundary of a touch or swipe action, but also sense a period of wakeup time and a pressure associated with the touch or swipe action. In some embodiments, the multimedia component 104 includes a front-facing camera and/or a rear-facing camera. When the electronic device 100 is in an operating mode, such as a shooting mode or a video mode, the front-facing camera and/or the rear-facing camera can receive external multimedia data. Each front-facing camera and rear-facing camera may be a fixed optical lens system or has focal length and optical zoom capability.

The audio component 105 is configured to output and/or input audio signals. For example, the audio component 105 includes a microphone (MIC) configured to receive an external audio signal when the electronic device 100 is in an operation mode, such as a call mode, a recording mode, and a voice recognition mode. The received audio signal may be further stored in the memory 102 or transmitted via the communication component 108. In some embodiments, the audio component 105 further includes a speaker to output audio signals.

The I/O interface 106 provides an interface between the processing component 101 and peripheral interface modules, such as a keyboard, a click wheel, buttons, and the like. The buttons may include, but are not limited to, a home button, a volume button, a starting button, and a locking button.

The sensor component 107 includes one or more sensors to provide status assessments of various aspects of the electronic device 100. For instance, the sensor component 107 may detect an open/closed status of the electronic device 100, relative positioning of components, e.g., the display and the keypad, of the electronic device 100, a change in position of the electronic device 100 or a component of the electronic device 100, a presence or absence of user contact with the electronic device 100, an orientation or an acceleration/deceleration of the electronic device 100, and a change in temperature of the electronic device 100. The sensor component 107 may include a proximity sensor configured to detect the presence of nearby objects without any physical contact. The sensor component 107 may also include a light sensor, such as a Complementary Metal Oxide Semiconductor (CMOS) or Charge-Coupled Device (CCD) image sensor, for use in imaging applications. In some embodiments, the sensor component 107 may also include an accelerometer sensor, a gyroscope sensor, a magnetic sensor, a pressure sensor, or a temperature sensor.

The communication component 108 is configured to facilitate communication, wired or wirelessly, between the electronic device 100 and other devices. The electronic device 100 can access a wireless network based on a communication standard, such as Wi-Fi, 2G or 3G, or a combination thereof. In an embodiment, the communication component 108 receives a broadcast signal or broadcast associated information from an external broadcast management system via a broadcast channel. In an embodiment, the communication component 108 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Blue Tooth (BT) technology, and other technologies.

In some embodiments, the electronic device 100 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, for performing the above described methods. It should be noted that the implementation process and technical principle of the electronic device in this embodiment can be referred to the above explanation of the audio signal encoding method in the embodiment of the disclosure, and will not be repeated here.

The electronic device 100 provided by the embodiment of the disclosure may execute the audio signal encoding method as described in some of the above embodiments, and its beneficial effects are the same as those of the above audio signal encoding method, which will not be repeated here.

In order to realize the above embodiments, the disclosure also provides a storage medium.

When the instructions stored in the storage medium are executed by the processor of the electronic device, the electronic device is caused to perform the audio signal encoding method described above. For example, the storage medium may be a ROM, a Random Access Memory (RAM), Compact Disc-ROM (CD-ROM), a magnetic tape, a floppy disk, an optical data storage device, etc.

In order to realize the above embodiments, the disclosure also provides a computer program product. When the computer program is executed by the processor of the electronic device, the electronic device is caused to perform the audio signal encoding method as described above.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and examples are considered as illustrative only, with a true scope and spirit of the disclosure being indicated by the following claims.

It is clearly understood by those skilled in the art that for the convenience and conciseness of description, the specific working processes of the systems, devices and units described above can be referred to the corresponding processes in the aforementioned method embodiments, and will not be repeated here.

The above descriptions are specific implementations of the disclosure, but the protection scope of the disclosure is not limited thereto. Any technician familiar with the technical field can easily think of changes or substitutions within the technical scope disclosed in the disclosure, which should be included in the protection scope of the disclosure. Therefore, the protection scope of the disclosure should be based on the protection scope of the attached claims.

1. An audio signal encoding method, comprising:
obtaining a scene-based audio signal;
determining a number of audio channels of the audio signal and an encoding rate; and
generating an encoded codestream by encoding the audio signal according to the number of audio channels and the encoding rate.

2. The method of claim 1, wherein generating the encoded codestream by encoding the audio signal according to the number of audio channels and the encoding rate, comprises:
performing a down-mixed processing on the audio signal according to the number of audio channels and the encoding rate to generate a down-mixed parameter and a down-mixed audio channel signal;
encoding the down-mixed audio channel signal to generate an encoding parameter; and
generating the encoded codestream by performing codestream multiplexing on the down-mixed parameter and the encoding parameter.

3. The method of claim 2, wherein performing the down-mixed processing on the audio signal according to the number of audio channels and the encoding rate to generate the down-mixed parameter and the down-mixed audio channel signal, comprises:
determining a target control parameter for the audio signal according to the number of audio channels and the encoding rate;
determining a down-mixed processing algorithm according to the target control parameter; and
performing the down-mixed processing on the audio signal according to the down-mixed processing algorithm to generate the down-mixed parameter and the down-mixed audio channel signal.

4. The method of claim 3, wherein determining the target control parameter for the audio signal according to the number of audio channels and the encoding rate, comprises:
calculating an initial average rate of each audio channel according to the number of audio channels and the encoding rate;
determining a target average rate according to the initial average rate and a preset average rate threshold; and
determining the target control parameter for the audio signal according to the initial average rate and the target average rate.

5. The method of claim 1, wherein before encoding the audio signal, the method further comprises:
performing a pre-emphasis preprocessing and/or a high-pass filtering preprocessing on the audio signal.

6-10. (canceled)

11. An electronic device, comprising:
a processor; and
a memory storing;
machine-readable instructions that, when executed by the processor, cause the processor to:
obtain a scene-based audio signal;
determine a number of audio channels of the audio signal and an encoding rate; and
generate an encoded codestream by encoding the audio signal according to the number of audio channels and the encoding rate.

12. A non-transitory computer-readable storage medium having computer instructions stored thereon, wherein when the computer instructions are executed by a processor, the processor is caused to perform:
obtaining a scene-based audio signal;
determining a number of audio channels of the audio signal and an encoding rate; and
generating an encoded codestream by encoding the audio signal according to the number of audio channels and the encoding rate.

13. (canceled)

14. The electronic device of claim 11, wherein generating the encoded codestream by encoding the audio signal according to the number of audio channels and the encoding rate, comprises:
performing a down-mixed processing on the audio signal according to the number of audio channels and the encoding rate to generate a down-mixed parameter and a down-mixed audio channel signal;
encoding the down-mixed audio channel signal to generate an encoding parameter; and
generating the encoded codestream by performing codestream multiplexing on the down-mixed parameter and the encoding parameter.

15. The electronic device of claim 14, wherein performing the down-mixed processing on the audio signal according to the number of audio channels and the encoding rate to generate the down-mixed parameter and the down-mixed audio channel signal, comprises:
determining a target control parameter for the audio signal according to the number of audio channels and the encoding rate;
determining a down-mixed processing algorithm according to the target control parameter; and
performing the down-mixed processing on the audio signal according to the down-mixed processing algorithm to generate the down-mixed parameter and the down-mixed audio channel signal.

16. The electronic device of claim 15, wherein determining the target control parameter for the audio signal according to the number of audio channels and the encoding rate, comprises:
calculating an initial average rate of each audio channel according to the number of audio channels and the encoding rate;
determining a target average rate according to the initial average rate and a preset average rate threshold; and
determining the target control parameter for the audio signal according to the initial average rate and the target average rate.

17. The electronic device of claim 11, wherein the processor is further configured to:
before encoding the audio signal, perform a pre-emphasis preprocessing and/or a high-pass filtering preprocessing on the audio signal.

18. The storage medium of claim 12, wherein generating the encoded codestream by encoding the audio signal according to the number of audio channels and the encoding rate, comprises:
performing a down-mixed processing on the audio signal according to the number of audio channels and the encoding rate to generate a down-mixed parameter and a down-mixed audio channel signal;
encoding the down-mixed audio channel signal to generate an encoding parameter; and
generating the encoded codestream by performing codestream multiplexing on the down-mixed parameter and the encoding parameter.

19. The storage medium of claim 18, wherein performing the down-mixed processing on the audio signal according to the number of audio channels and the encoding rate to generate the down-mixed parameter and the down-mixed audio channel signal, comprises:
determining a target control parameter for the audio signal according to the number of audio channels and the encoding rate;
determining a down-mixed processing algorithm according to the target control parameter; and
performing the down-mixed processing on the audio signal according to the down-mixed processing algorithm to generate the down-mixed parameter and the down-mixed audio channel signal.

20. The storage medium of claim 19, wherein determining the target control parameter for the audio signal according to the number of audio channels and the encoding rate, comprises:
calculating an initial average rate of each audio channel according to the number of audio channels and the encoding rate;
determining a target average rate according to the initial average rate and a preset average rate threshold; and
determining the target control parameter for the audio signal according to the initial average rate and the target average rate.

21. The storage medium of claim 12, wherein the processor is further configured to:
before encoding the audio signal, perform a pre-emphasis preprocessing and/or a high-pass filtering preprocessing on the audio signal.
